(19) United States
(12) Patent Application Publication
(10) Pub. No.: US 2015/0376369 A1
(43) Pub. Date: Dec. 31, 2015

(54) THERMALLY CONDUCTIVE COMPOSITIONS AND CABLES THEREOF

(71) Applicant: GENERAL CABLE TECHNOLOGIES CORPORATION, Highland Heights, KY (US)

(72) Inventors: Sathish Kumar Ranganathan, Indianapolis, IN (US); Sean William Culligan, Zionsville, IN (US); Cody R. Davis, Maineville, OH (US); Srinivas Siripurapu, Carmel, IN (US); Vijay Mhetar, Carmel, IN (US)

(21) Appl. No.: 14/752,454

(22) Filed: Jun. 26, 2015

Related U.S. Application Data
(60) Provisional application No. 62/018,110, filed on Jun. 27, 2014.

(51) Int. Cl. C08K 3/34; H01B 9/00; H01B 3/30; H01B 7/02; C08K 3/22; C08K 3/28

(52) U.S. Cl. CPC C08K 3/346; C08K 3/34; C08K 3/22; C08K 3/28; H01B 3/307; H01B 7/0216; H01B 9/00; C08K 2003/2296; C08K 2003/222; C08K 2003/2227

(57) ABSTRACT

A thermoset composition can include a cross-linked polyolefin; a primary filler selected from the group consisting of talc, calcined clay, or combinations thereof; a secondary filler selected from one or more of a metal oxide and a metal nitride, and one of a composition stabilizer and antioxidant. The thermoset composition can exhibit a thermal conductivity of at least about 0.27 W/mK, and/or a dielectric loss tangent of less than about 3% when measured at 90° C. The thermoset composition can be used in the construction on an insulation layer or jacket layer of a power cable.

### REFERENCE TO RELATED APPLICATION

The present application claims the priority of U.S. Provisional Application Ser. No. 62/018,110, entitled THERMALLY CONDUCTIVE COMPOSITIONS AND CABLES THEREOF, filed Jun. 27, 2014, and hereby incorporates the same application herein by reference in its entirety.

### TECHNICAL FIELD

The present disclosure generally relates to thermoset compositions exhibiting high thermal conductivity and which are useful in the construction of power cables.

### BACKGROUND

Conventional power cables typically include a conductor surrounded by one or more insulation layers or jacket layers. Such insulation and jacket layers provide certain desired properties to the power cable. However, conductor resistance losses inherent to electric power transmission can generate heat at the conductor which must be dissipated through the surrounding layers. The construction of a power cable with thermally conductive insulation layers and/or jacket layers would allow for construction of a more efficient power cable for a given gauge by minimizing temperature dependent resistance losses. Consequently, there is a need for a thermally conductive composition for power cables that exhibits increased thermal conductance while still providing required electrical, physical and mechanical properties.

### SUMMARY

In accordance with one example, a thermoset composition includes about 100 parts by weight of the thermoset composition, of a cross-linked polyolefin. The thermoset composition further includes from about 80 parts to about 160 parts, by weight of the thermoset composition, of a primary filler. The primary filler is selected from the group consisting of talc, calcined clay, and combinations thereof. The thermoset composition further includes a secondary filler selected from one or more of a metal oxide and a metal nitride. The thermoset composition further includes from about 0.5 parts to about 10 parts, by weight of the thermoset composition, of at least one of a composition stabilizer and an antioxidant. The thermoset composition exhibits a thermal conductivity of about 0.27 W/mK or greater, a dielectric loss tangent of about 3% or less when measured at about 90° C. after water aging for about eight weeks, or both.

In accordance with another example, a cable comprises a conductor and an insulation layer surrounding the conductor. The insulation layer can be formed from a thermoset composition. The thermoset composition includes about 100 parts by weight of the thermoset composition, of a cross-linked polyolefin. The thermoset composition further includes from about 80 parts to about 160 parts, by weight of the thermoset composition, of a primary filler. The primary filler is selected from the group consisting of talc, calcined clay, and combinations thereof. The thermoset composition further includes a secondary filler selected from one or more of a metal oxide and a metal nitride. The thermoset composition further includes from about 0.5 parts to about 10 parts, by weight of the thermoset composition, of at least one of a composition stabilizer and an antioxidant. The thermoset composition exhibits a thermal conductivity of about 0.27 W/mK or greater, a dielectric loss tangent of about 3% or less when measured at about 90° C. after water aging for about eight weeks, or both.

### BRIEF DESCRIPTION OF THE DRAWINGS

FIG. 1 depicts a perspective view of a power cable having an insulation layer formed from a thermoset composition.

FIG. 2 depicts a schematic view of a series loop to evaluate a temperature difference between two different power cable coatings.

### DETAILED DESCRIPTION

Thermoset compositions can generally be useful in the operation and construction of a power cable. For example, thermoset compositions can be useful in the formation of at least one insulation layer or jacket layer in the power cable. The thermoset compositions used in such insulation and jacket layers can surround a conductor and can produce, or influence, certain bulk properties of the power cable including, for example, a power cable's electrical, physical, and mechanical properties.

The present thermoset compositions can allow for the construction of power cables having improved heat transfer properties while also achieving the physical, mechanical, and electrical properties necessary for operation and use of the power cable. As a non-limiting example, a thermoset composition according to one embodiment can have a thermal conductivity, measured in accordance with the ASTM E1952 (2011) mDSC method at 75° C., that can exceed about 0.27 W/mK. The thermoset composition can additionally meet other physical, or mechanical, requirements such as having an elongation at break greater than 200%, or being configured to pass the long term insulation resistance (“LTIR”) requirements of UL 44 (2010) under 75° C. or 90° C. wet conditions. In certain embodiments, a thermoset composition according to one embodiment can have a thermal conductivity of about 0.28 W/mK or higher; and in certain embodiments, a thermal conductivity of about 0.29 W/mK or higher; in certain embodiments, a thermal conductivity of about 0.30 W/mK or higher; in certain embodiments, a thermal conductivity of about 0.31 W/mK or higher; and in certain embodiments, a thermal conductivity of about 0.32 W/mK or higher.

According to certain embodiments, a thermoset composition can be formed from a cross-linked polyolefin. Such a composition can further include one or more of a plurality of additional components including, for example, a base polymer (e.g., polyolefin), a primary filler, a composition stabilizer, and an antioxidant. As will be appreciated, additional components can also be added to the composition according to certain embodiments.

In certain embodiments, a thermoset composition can include any polymeric resin having a melting point below about 150° C. and a glass transition temperature about 25° C. or less, such as, for example, certain polymerized alkene compounds having a base monomer with formula CₙH₂ₙ. In one embodiment, such polymerized alkene can be polyethylene.

According to certain embodiments, a thermoset composition can additionally, or alternatively, comprise copolymers, blends, and mixtures of several different polymers. For example, the base component can be formed from the polymerization of ethylene with at least one comonomer selected from the group consisting of C₃ to C₂₀ alpha-olefins and C₃ to C₂₀ polyenes. As will be appreciated, polymerization of ethylene with such comonomers can produce ethylene/alpha-olefin copolymers or ethylene/alpha-olefin/diene terpolymers.

According to certain embodiments, the alpha-olefins can alternatively contain between about 3 to about 16 carbon atoms or can contain between about 3 to about 8 carbon atoms. A non-limiting list of suitable alpha-olefins includes propylene, 1-butene, 1-pentene, 1-hexene, 1-octene, and 1-dodecene.

Likewise, according to certain embodiments, a polyene can alternatively contain between about 4 to about 20 carbon atoms, or can contain between about 4 to about 15 carbon atoms. In certain embodiments, the polyene can be a diene further including, for example, straight chain dienes, branched chain dienes, cyclic hydrocarbon dienes, and non-conjugated dienes. Non-limiting examples of suitable dienes can include straight chain acyclic dienes: 1,3-butadiene; 1,4-hexadiene, and 1,6-octadiene; branched chain acyclic dienes: 5-methyl-1,4-hexadiene; 3,7-dimethyl-1,6-octadiene; 3,7-dimethyl-1,7-octadiene; and mixed isomers of dihydro myricene and dihydroocinene; single ring alicyclic dienes: 1,3-cyclopentadiene; 1,4-cylcohexadiene; 1,5-cyclooctadiene; and 1,5-cyclododecadiene; multi-ring alicyclic fused and bridged ring dienes: tetrahydroindene; methyl tetrahydroindene; dicylcopentadiene; bicyclo-(2,2,1)-hepta-2-5-diene; alkenyl; alkylidene; cycloalkenyl; and cycloalkylidene norbornenes such as 5-methylene-2morbornene (MNB); 5-propenyl-2-norbornene; 5-isopropylidene-2-norbornene; 5-(4-cyclopentenyl)-2-norbornene; 5-cyclohexylidene-2-norbornene; and norbornene.

A polyolefin of a thermoset composition can be polymerized by any suitable method including, for example, metallocene catalysis reactions. Details of metallocene catalyzation processes are disclosed in U.S. Pat. No. 6,451,894, U.S. Pat. No. 6,376,623, and U.S. Pat. No. 6,329,454, all of which are hereby incorporated by reference in their entirety into the present application. Metallocene-catalyzed olefin copolymers can also be commercially obtained through various suppliers including ExxonMobil Chemical Company (Houston, Tex.) and Dow Chemical Company. Metallocene catalysis can allow for the polymerization of precise polymeric structures.

As non-limiting examples, suitable polyolefins can include ethylene-butene copolymer, ethylene propylene-diene terpolymer, ethylene-octene copolymer, ethylene-propylene rubber, and polyethylene. The thermoset composition can include about 100 parts by weight of the polyolefin.

According to certain embodiments, a thermoset composition can include primary filler. Such primary fillers can include talc, calcined clay, and combinations thereof. Particles of the primary filler can vary in size and can have an average particle size between about 50 nm to about 200 microns according to certain embodiments. Particles can also vary in shape, and such suitable shapes of the primary filler can include spherical, hexagonal, platy, tabular, etc. In certain embodiments, the average particle size of a portion of the primary filler can also be selected. For example, in certain embodiments, about 80%, or more, of the particles in the primary filler can have an average particle size of about 20 microns or less. In certain embodiments, the primary filler can be included at about 80 parts to about 160 part weight of the thermoset composition. In certain embodiments, a primary filler can include about 110 parts to about 130 parts by weight of the thermoset composition.

According to certain embodiments, the composition stabilizer of the thermoset composition can include at least one of an ultraviolet (“UV”) stabilizer, a light stabilizer, a heat stabilizer, a lead stabilizer, a metal deactivator; or any other suitable stabilizer. In certain embodiments, a composition stabilizer can be present in the thermoset composition from about 0.5 part to about 10 parts, by weight; in certain embodiments from about 1 part to about 8 parts; and in certain embodiments from about 1.5 parts to about 5 parts.

Suitable UV stabilizers can be selected, for example, from compounds including: benzophenones, triazines, banzoxazinones, benzotriazoles, benzoates, formamidines, cinnamates/propenoates, aromatic propanediones, benzimidazoles, cycloaliphatic ketones, formanilides, cyanoacrylates, benzopyranones, salicylates, and combinations thereof. Specific examples of UV stabilizers can include 2,2″-methylenebis(6-(2H-benzotriazol-2-yl)-4-4(1,1,3,3,-tetramethylbutyl) phenol, available as LA-31 RG from Adeka Palmarole (Saint Louis, France) having CAS #103597-45-1; and 2,2′-(p-phenylene) bis-4-H-3,1-benzoxazin-4-one, available as Cyasorb UV-3638 from Cytec Industries (Stamford, Conn.) and having CAS #18600-59-4.

Hindered amine light stabilizers (“HALS”) can be used as a light stabilizer according to certain embodiments. HALS can include, for example, bis(2,2,6,6-tetramethyl-4-piperidyl)sebaceate; bis(1,2,2,6,6-tetramethyl-4-piperidyl)sebaceate with methyl 1,2,2,6,6-tetrameth-yl-4-piperidyl sebaceate; 1,6-hexanediamine, N,N′-bis(2,2,6,6-tetramethyl-4-piperidyl)polymer with 2,4,6 trichloro-1,3,5-triazine; reaction products with N-butyl2,2,6,6-tetramethyl-4-piperidinamine; decanedioic acid; bis(2,2,6,6-tetramethyl-1-(octyloxy)-4-piperidyl)ester; reaction products with 1,1-dimethylethylhydroperoxide and octane; triazine derivatives; butanedioc acid; dimethylester, polymer with 4-hydroxy-2,2,6,6-tetramethyl-1-piperidine ethanol; 1,3,5-triazine-2,4,6-triamine,N,N′″-[1,2-ethane-diyl-bis[[[4,6-bis-[butyl(1,2,2,6,6pentamethyl-4-piperdinyl)amino]-1,3,5-triazine-2-yl]imino-]-3,1-propanediyl]]bis[N′,N″-dibutyl-N′,N″bis(2,2,6,6-tetramethyl-4-pipe-ridyl); bis (1,2,2,6,6-pentamethyl-4-piperidinyl) sebacate; poly[[6-[(1,1,3,3-terramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]]; benzenepropanoic acid; 3,5-bis(1,1-dimethyl-ethyl)-4-hydroxy-C7-C9 branched alkyl esters; and isotridecyl-3-(3,5-di-tert-butyl-4-hydroxyphenyl) propionate. In one embodiment, a suitable HALS can be bis(1,2,2,6,6-pentamethyl-4-piperidinyl) sebacate.

A heat stabilizer can include, but is not limited to, 4,6-bis (octylthiomethyl)-o-cresol dioctadecyl 3,3′-thiodipropionate; poly[[6-[(1,1,3,3-terramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]]; benzenepropanoic acid; 3,5-bis(1,1-dimethyl-ethyl)-4-hydroxy-C7-C9 branched alkyl esters; and isotridecyl-3-(3,5-di-tert-butyl-4-hydroxyphenyl) propionate. According to some embodiments, the heat stabilizer can be 4,6-bis (octylthiomethyl)-o-cresol; dioctadecyl 3,3′-thiodipropionate and/or poly[[6-[(1,1,3,3-terramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]].

A lead stabilizer can include a lead oxide, such as for example, red lead oxide Pb₃O₄. However, as will be appreciated, any other suitable lead stabilizer can also be used alone or in combination with red lead oxide. In some embodiments, however, the thermoset composition can alternatively be substantially lead-free. As will be appreciated, lead-free compositions can be advantageous for safety reasons and can allow for wider usage of the compositions.

A metal deactivator can include, for example, N,N′-bis(3-(3,5-di-t-butyl-4-hydroxyphenyl)propionyl)hydrazine, 3-(N-salicyloyl)amino-1,2,4-triazole, and/or 2,2′-oxamidobis-(ethyl 3-(3,5-di-t-butyl-4-hydroxyphenyl)propionate).

According to certain embodiments, an antioxidant can include, for example, amine-antioxidants, such as 4,4′-dioctyl diphenylamine, N,N′-diphenyl-p-phenylenediamine, and polymers of 2,2,4-trimethyl-1,2-dihydroquinoline; phenolic antioxidants, such as thiodiethylene bis[3-(3,5-di-tert-butyl-4-hydroxyphenyl)propionate], 4,4′-thiobis(2-tert-butyl-5-methylphenol), 2,2′-thiobis(4-methyl-6-tert-butyl-phenol), benzenepropanoic acid, 3,5-bis(1,1-dimethylethyl)4-hydroxy benzenepropanoic acid, 3,5-bis(1,1-dimethylethyl)-4-hydroxy-C13-15 branched and linear alkyl esters, 3,5-di-tert-butyl-4hydroxyhydrocinnamic acid C7-9-branched alkyl ester, 2,4-dimethyl-6-t-butylphenol tetrakis {methylene-3-(3′,5′-ditert-butyl-4′-hydroxyphenol)propionate}methane or tetrakis {methylene3-(3′,5′-ditert-butyl-4′-hydrocinnamate}methane, 1,1,3tris(2-methyl-4-hydroxyl-5-butylphenyl)butane, 2,5,di t-amyl hydroqunone, 1,3,5-tri methyl2,4,6tris(3,5 di tert butyl-4-hydroxybenzyl)benzene, 1,3,5tris(3,5 di-tert-butyl-4-hydroxybenzyl)isocyanurate, 2,2-methylene-bis-(4-methyl-6-tert butyl-phenol), 6,6′-di-tert-butyl-2,2′-thiodi-p-cresol or 2,2′-thiobis(4-methyl-6-tert-butylphenol), 2,2-ethylenebis(4,6-di-t-butylphenol), triethyleneglycol bis {3-(3-t-butyl-4-hydroxy-5methylphenyl)propionate}, 1,3,5-tris(4tert-butyl-3-hydroxy-2,6-dimethylbenzyl)-1,3,5-triazine-2,4,6-(1H,3H,5H)trione, 2,2-methylenebis{6-(1-methylcyclohexyl)-p-cresol}; and/or sulfur antioxidants, such as bis(2-methyl-4-(3-n-alkylthiopropionyloxy)-5-t-butylphenyl)sulfide, 2-mercaptobenzimidazole and its zinc salts, pentaerythritol-tetrakis(3-lauryl-thiopropionate), and combinations thereof.

In certain embodiments, a thermoset composition can include additional components/ingredients. For example, a thermoset composition can additionally include a secondary filler. The secondary filler can be a metal oxide, a metal nitride, or a combination of several such metal oxides and metal nitrides. Metal oxides suitable for inclusion in the thermoset composition can include zinc oxide, magnesium oxide, aluminum oxide, and silicon dioxide. As will be appreciated, aluminum oxide and silicon dioxide can optionally be supplied as spherical alumina and spherical silica respectively. Metal nitrides suitable for inclusion as a secondary filler can include boron nitride, and aluminum nitride. The secondary filler can be included, according to one embodiment, at a level ranging from about 5 parts to about 60 parts by weight of the thermoset composition or at a level of about 5 parts to about 40 parts by weight of the thermoset composition. In comparison to the primary filler, the secondary filler can be present at levels about 50% or less by weight of the total fillers (e.g., primary fillers and secondary fillers). The average particle size of the total filler can be about 50 microns or less in certain embodiments, about 20 microns or less in certain embodiments, and about 2 microns or less in certain embodiments.

According to certain embodiments, a colorant may also be added to the thermoset composition. Suitable colorants can include carbon black, cadmium red, iron blue, or a combination thereof. However, according to certain embodiments, the composition can alternatively, or additionally, be substantially free of carbon black and other black derivatives while maintaining high thermal conductivity. In certain embodiments, compositions can be substantially non-black in appearance.

In certain embodiments, a thermoset composition can further include a surface treatment agent. Suitable surface treatment agents can include one or more of a monomeric vinyl silane, a polymeric vinyl silane, and an organosilane compound. Suitable organosilane compounds can include: y-methacryloxypropyltrimethoxysilane, methyltriethoxysilane, methyltris(2-methoxyethoxy)silane, dimethyldiethoxysilane, vinyltris(2-methoxyethoxy)silane, vinyltrimethoxysilane, vinyltriethoxysilane, octyltriethoxysilane, isobutyltriethoxysilane, isobutyltrimethoxysilane, propyltriethoxysilane, and mixtures or polymers thereof. In certain embodiments, a surface treatment agent can be included in the thermoset composition from about 0.5 part to about 10 parts by weight; and in certain embodiments, from about 0.5 part to about 5 parts by weight. As can be appreciated, the primary and secondary fillers can also optionally be pre-treated with the surface treatment agent.

According to certain embodiments, a thermoset composition can further include a processing oil. A processing oil can be used to improve the processability of the thermoset composition by forming a microscopic dispersed phase within the polymer carrier. During processing, the applied shear can separate the process aid (e.g., processing oil) phase from the carrier polymer phase. The processing oil can then migrate to the die wall to gradually form a continuous coating layer to reduce the backpressure of the extruder and reduce friction during extrusion. The processing oil can generally be a lubricant, such as, stearic acid, silicones, anti-static amines, organic amities, ethanolamides, mono- and di-glyceride fatty amines, ethoxylated fatty amines, fatty acids, zinc stearate, stearic acids, palmitic acids, calcium stearate, zinc sulfate, oligomeric olefin oil, or combinations thereof. In certain embodiments, the processing oil can be included from about 10 parts by weight or less of the thermoset composition; in certain embodiments from about 5 parts or less by weight of the thermoset composition; and in certain embodiments, from about 1 part or less by weight of the thermoset composition. In certain embodiments, the thermoset composition can be substantially free of any processing oil. As used herein, “substantially free” means that the component is not intentionally added to the composition and, or alternatively, that the component is not detectable with current analytical methods.

A processing oil can alternatively be a blend of fatty acids, such as the commercially available products: Struktol® produced by Struktol Co. (Stow, Ohio), Akulon® Ultraflow produced by DSM N.V. (Birmingham, Mich.), MoldWiz® produced by Axel Plastics Research Laboratories (Woodside, N.Y.), and Aflux® produced by RheinChemie (Chardon, Ohio).

According to certain embodiments, still additional components can be added to the thermoset composition. For example, a paraffin wax, a nucleating agent, or both can be added to the thermoset composition.

In certain embodiments, a composition can be partially or fully cross-linked through a suitable cross-linking agent or method to form a thermoset composition. A non-limiting example of a suitable class of cross-linking agents includes peroxide cross-linking agents such as, for example, α,α′-bis(tert-butylperoxy) disopropylbenzene, di(tert-butylperoxyisopropyl)benzene, dicumyl peroxide, and tert-butylcumyl peroxide. Blends of multiple peroxide cross-linking agents can also be used, such as for example, a blend of 1,1-dimethylethyl 1-methyl-1-phenylethyl peroxide, bis(1-methyl-1-phenylethyl) peroxide, and [1,3 (or 1,4)-phenylenebis(1-methylethylidene)]bis(1,1-dimethylethyl) peroxide. However, it will be appreciated that other suitable cross-linking agent or method can also be utilized to cross-link the thermoset composition, such as for example, radiation cross-linking, heat cross-linking, electron-beam irradiation, addition cross-linking, platinum cured cross-linking, and silane cross-linking agents. Suitable quantities of the cross-linking agent can vary from about 1 part to about 8 parts, from about 1 part to about 5 parts, and from about 1 part to about 3 parts, by weight of the thermoset composition.

Thermoset compositions can be prepared by blending the components/ingredients in conventional masticating equipment, for example, a rubber mill, brabender mixer, banbury mixer, buss-ko kneader, farrel continuous mixer, or twin screw continuous mixer. The components can be premixed before addition to the base polyer (e.g., polyolefin). The mixing time can be selected to ensure a homogenous mixture.

Thermoset compositions can exhibit a variety of physical, mechanical, and electrical properties. For example, a thermoset composition can have any combination of: an elongation at break when measured in accordance with ASTM D412 (2010) using molded plaques, a breakdown strength, an insulation resistance, or a Mooney viscosity at about 150° C. In certain embodiments, the elongation at break of the thermoset composition can be about 200% or more when measure in accordance with ASTM D412 (2010); in certain embodiments the elongation at break can be about 225% or more; and in certain embodiments the elongation at break can be about 250%. In certain embodiments, the breakdown strength of the thermoset composition can be about 500 V/mil or more; in certain embodiments the breakdown strength can be about 600 V/mil or more; and in certain embodiments the breakdown strength can be about 700 V/mil or more. In certain embodiments, the breakdown strength can remain about 500 V/mil after heat aging at 90° C. for 120 days. In certain embodiments, the insulation resistance can be about 10⁹ ohms or more; and in certain embodiments the insulation resistance can be about 10¹⁰ ohms or more. In certain embodiments, the Mooney viscosity of the thermoset composition can about 30 ML or less at about 150° C.; in certain embodiments the Mooney viscosity can about 25 ML or less at about 150° C.; and in certain embodiments the Mooney viscosity can about 20 ML or less at about 150° C.

The thermoset composition can additionally exhibit stable electrical properties under both dry and wet conditions. For example, the dielectric constant of the thermoset composition can be about 3.5 or less when measured at 90° C. under dry conditions and can remain about 3.5 or less after water aging at about 90° C. for about eight weeks in accordance with UL 44 LTIR requirements. Similarly, the dielectric loss tangent can be about 3.5% or less when measured under dry conditions at about 90° C. and can be about 3% or less after water aging for eight weeks in accordance with UL 44 LTIR requirements.

The thermoset composition, having good physical, mechanical, and electrical properties can be useful in a variety of applications including, for example, use in electronic applications, light-emitting diodes, the pipe industry, in heat pumps, and in solar cell backings. The thermoset composition can be produced or applied in any suitable manner including extrusion, injection molding, and other appropriate processes. The thermoset composition can be particularly useful in these applications as a heat-transfer material that still retains good mechanical and electrical properties. The thermoset composition can also be substantially non-black in appearance.

In certain embodiments, a thermoset composition can also be extruded onto a conductor to form a power cable having advantageous physical, mechanical, and electrical properties. As will be appreciated, power cables with such properties can be useful in a variety of applications including, for example, use as power transmission cables, distribution cables, underground cables, elevated cables, over ground cables, subsea cables, nuclear cables, mining cables, industrial power cables, transit cables, and as renewal energy cables for applications like solar and wind energy generation.

In a typical extrusion method, an optionally heated conductor can be pulled through a heated extrusion die, generally a cross-head die, to apply a layer of melted thermoset composition onto the conductor. Upon exiting the die, if the polymer is adapted as a thermoset composition, the conducting core with the applied polymer layer may be passed through a heated vulcanizing section, or continuous vulcanizing section and then a cooling section, generally an elongated cooling bath, to cool. Multiple polymer layers may be applied by consecutive extrusion steps in which an additional layer is added in each step, or with the proper type of die, multiple polymer layers may be applied simultaneously.

As can be appreciated, power cables can be formed in a variety of configurations including as single-core cables, multi-core cables, tray cables, inter-locked armored cables, and continuously corrugated welded (“CCW”) cable constructions. The conductors in such power cables can be surrounded by one or more insulation layers and/or jacket layers. According to certain embodiments, at least one of these insulation layers or jacket layers can be formed with the inventive thermoset composition. For example, a power cable can have an insulation layer and a jacket layer both of which can be formed of an inventive thermoset composition. Alternatively, in other embodiments, a power cable can comprise an insulation layer formed from an inventive thermoset composition and a jacket layer formed from a second, different, composition. Such a selection can be made for a variety of reasons including functionality, and price of the desired power cable.

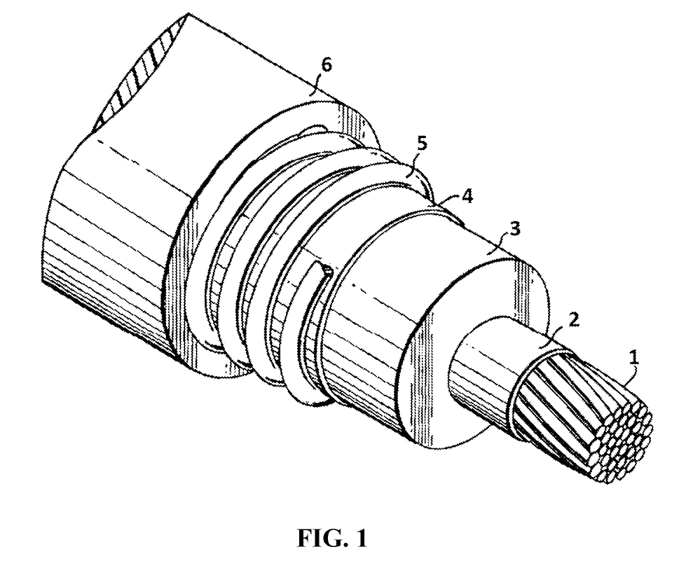

An illustrative, single-core, power cable is depicted in FIG. 1. The single-core power cable in FIG. 1 has a conductor 1, a conductor shield 2, a thermoset insulation layer 3, an insulation shield 4, a neutral wire 5, and a jacket layer 6. Either, or both, of the thermoset insulation layer 3 and the jacket layer 6 can be formed with an inventive thermoset composition to improve the properties of the power cable. As will be appreciated, certain power cables can also be formed having fewer components and can, for example, optionally omit one or more of the conductor shield 2, insulation shield 4, neutral wire 5, and jacket layer 6.

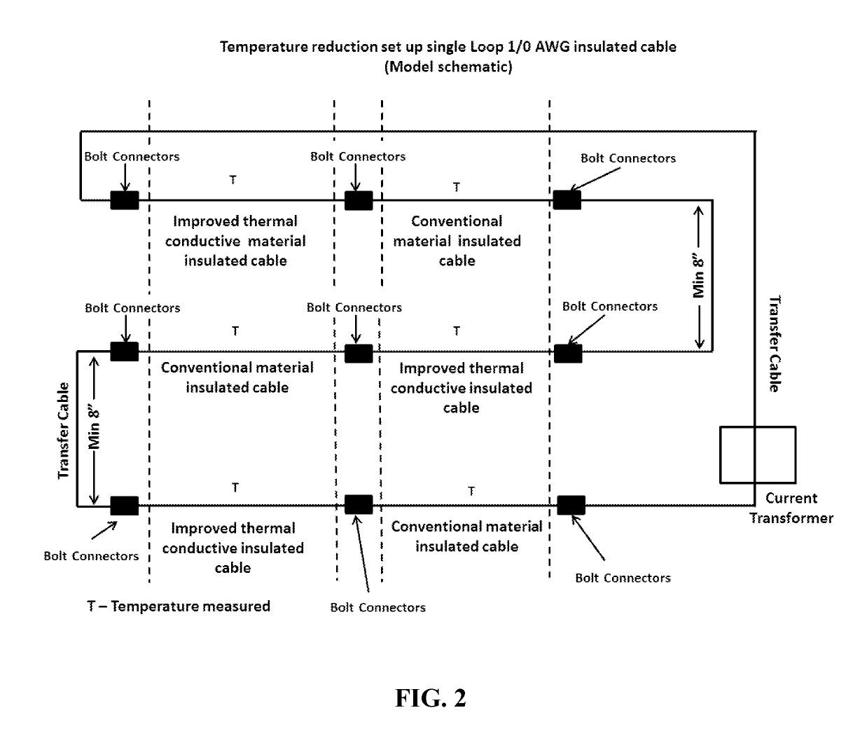

One way to reduce the conductor temperature is by transmitting heat to the surrounding coating layer, which subsequently dissipates the heat to the surrounding environment through at least one of radiation, conduction or convection. The amount of heat transmitted through the surrounding layers is dependent on the thermal conductivity and emissivity of the coating layer. A higher thermal conductivity and emissivity of a coating layer helps to lower conductor temperature compared to a bare conductor. Such a temperature reduction can be measured using 1/0 American Wire Gauge (“AWG”) aluminum conductor insulation cables using a modified ANSI test and the setup depicted in FIG. 2.

The modified ANSI test sets up a series loop using six, identically sized, four-foot cable specimens and four transfer cables as depicted in FIG. 1. Three of the four-foot cable specimens are coated with conventional insulation materials and three of the four-foot cable specimens are coated with a thermoset composition as described herein. As illustrated by FIG. 2, two alternating sets are formed with each set having three cable specimens. Equalizers (e.g., shown as bolt separators in FIG. 2) are placed between each cable specimen to provide equipotential planes for resistance measurements and ensure permanent contacts between all cable specimens. Each equalizer has a formed hole matching the gauge of the cable specimens and each cable specimen is welded into the holes. Temperature was measured on the conductor surface of each cable specimen at locations ‘T’ in FIG. 2 while supplying constant current and voltage from a transformer.

According to certain embodiments, a power cable having an insulation layer formed of an inventive thermoset composition as described herein can operate at a reduced temperature of about 5° C. or more when operated in a 90° C. operating environment than that of a different, comparative, cable constructed without an inventive thermoset composition. As an illustration only, a different, comparative, thermoset composition may be constructed without the requisite primary filler loading, or be constructed without meeting the thermal conductivity or dielectric loss tangent properties of an inventive thermoset composition. In certain embodiments, a power cable having an insulation layer formed of an inventive thermoset composition as described herein can operate at a reduced temperature of about 10° ° C. or more when operated in a 90° ° C. operating environment than that of a different, comparative, cable constructed without an inventive thermoset composition.

The conductor, or conductive element, of a power cable, can generally include any suitable electrically conducting material. For example, a generally electrically conductive metal such as, for example, copper, aluminum, a copper alloy, an aluminum alloy (e.g. aluminum-zirconium alloy), or any other conductive metal can serve as the conductive material. As will be appreciated, the conductor can be solid, or can be twisted and braided from a plurality of smaller conductors. The conductor can be sized for specific purposes. For example, a conductor can range from a 1 kcmil conductor to a 1,500 kcmil conductor in certain embodiments, a 4 kcmil conductor to a 1,000 kcmil conductor in certain embodiments, a 50 kcmil conductor to a 500 kcmil conductor in certain embodiments, or a 100 kcmil conductor to a 500 kcmil conductor in certain embodiments. The voltage class of a power cable including such conductors can also be selected. For example, a power cable including a 1 kcmil conductor to a 1,500 kcmil conductor and an insulating layer formed from a suitable thermoset composition can have a voltage class ranging from about 1 kV to about 150 kV in certain embodiments, or a voltage class ranging from about 2 kV to about 65 kV in certain embodiments. In certain embodiments, a power cable can also meet the medium voltage electrical properties of ICEA test standard S-94-649-2004.

### Examples

Table 1 lists suitable materials for each of the components used in the inventive and comparative examples in Tables 2 to 11 produced below.

TABLE 1

| Material | Trade Name | Supplier |
|---|---|---|
| Ethylene-Butene | Engage 7447 | Dow Chemicals |
| Copolymer | | |
| Ethylene-Butene | Exact 4006 | ExxonMobil |
| Copolymer | | |
| Ethylene-Octene | Engage 8411 | Dow Chemicals |
| Copolymer | | |
| Ethylene-Propylene | Vistalon 722 | ExxonMobil |
| Rubber | | |
| EPDM | Royalene 525 | Lion polymers |
| EPDM | Royaledge 5041 | Lion polymers |
| EPDM | Nordel 3722 P | Dow chemicals |
| Polyethylene | DYNH 1-PE | Dow chemicals |
| Calcium Carbonate | ULTRA-PFLEX | Speciality Minerals |
| Spherical Alumina | AL3-75 | Sanyo Corporation |
| Mullite | Duramal EG | Reade Advance materials |
| Spherical silica | HS 301 | Sanyo Corporation |
| Talc | Jetfil 575 C | Imerys |
| Boron Nitride | Boron Nitride | Momentive performance |
| | Powder HCV | materials |
| Calcined clay | Polyfil 90 | KaMin, LLC |
| Calcined clay | Sanitone | BASF |
| | W(whitetex) | |
| Calcined clay | Translink 37 | BASF |
| Aluminium Nitride | ALN-AT | ABCR GmbH & Co. KG |
| Zinc Oxide | AZO 66 | US Zinc |
| Process oil | Sunpar Oil 2280 | Sunoco |
| Vinyl Silane | Dynasylan 6598 | Evonik |
| Paraffin wax | CS 2037P (Wax) | HB Chemicals |
| Antioxidant | Agerite Resin D | R. T. Vanderbilt |
| UV stabilizer | Tinuvin 622 LD | Ciba |
| Metal Deactivator | Irganox MD 1024 | Ciba |
| Lead stabilizer | Rhenogran | Rheinchemie |
| | Pb3O4-90/ | |
| | EPDM¹ | |
| Peroxide | D-16 (Luperox) | Arkema |
| Peroxide | Perkadox BC-FF | Akzonobel |

¹Rhenogram Pb₃O₄-90/EPDM is a 90% lead stabilizer masterbatch in EPDM.

Example thermoset compositions were produced using various components from Table 1 by mixing each listed component together in each example, with the exception of the base polymer to form a mixture. This mixture was then added to the base polymer and blended using conventional masticating equipment. Mixing was then performed until a homogenous blend was obtained. Cables were produced by extruding the homogenous thermoset composition onto a 14 AWG copper conductor insulated wire cable using conventional extrusion techniques.

TABLE 2

| | Inventive Examples | | | | Comparative Examples | | |
|---|---|---|---|---|---|---|---|
| Component | 1 | 2 | 3 | 4 | 5 | 6 | 7 |
| Ethylene-Butene copolymer¹ | 100 | 100 | 100 | 100 | 90 | 90 | 100 |
| Polyethylene | — | — | — | — | 20 | 20 | — |
| Calcined clay² | 120 | 115 | — | — | 50 | 50 | 120 |
| Talc | — | — | 100 | 100 | — | — | — |
| Boron Nitride | — | 5 | — | — | — | — | — |
| Aluminum Nitride | — | — | 5 | 5 | — | — | — |
| Process Oil | — | — | — | — | — | — | 20 |
| Paraffin wax | 5 | 5 | 5 | 5 | 5 | 5 | 5 |
| Vinyl Silane | 2 | 3 | 2 | 2 | 1 | 0.5 | 2 |
| Zinc Oxide | 5 | 5 | 5 | 5 | 5 | 5 | 5 |
| Antioxidant | 2 | 2.5 | 2.5 | 2.5 | 0.75 | 0.75 | 2 |
| UV stabilizer | — | — | — | — | 0.75 | — | — |
| Metal Deactivator | — | — | — | 1.5 | — | — | — |
| Lead Stabilizer³ | 5 | 6 | 6 | — | — | 5 | 5 |
| Peroxide⁴ | 2.5 | 2.5 | 2.5 | 2.5 | 2.5 | 2.5 | 2.5 |
| Total (parts) | 242 | 244 | 228 | 223.5 | 175 | 178.8 | 262 |

¹Engage 7447, produced by Dow Chemicals
²Polyfil 90 by KaMin, LLC
³90% masterbatch in EPDM
⁴D-16 (Luperox) by Arkema

Table 2 discloses Examples 1 to 7 of thermoset compositions. Examples 1 to 4 are inventive examples and disclose compositions that exhibit a thermal conductivity of at least 0.28 W/mK, an elongation at break of at least 200%, and favorable dry and wet dielectric properties. Examples 5 to 7 are comparative examples as the compositions exhibit thermal conductivity less than 0.27 W/mK.

As depicted in Table 3, measurements, including thermal conductivity, elongation at break, and electrical properties, were measured for each of Examples 1 to 7 using either test plaques or 14 AWG copper conductor cables prepared with such thermoset compositions.

TABLE 3

| | Inventive Examples | | | | Comparative Examples | | |
|---|---|---|---|---|---|---|---|
| | 1 | 2 | 3 | 4 | 5 | 6 | 7 |
| Thermal and Mechanical Data | | | | | | | |
| Thermal Conductivity (W/mK) | 0.28 | 0.29 | 0.32 | 0.32 | 0.18 | 0.18 | 0.26 |
| Tensile Elongation at break (%) | 275 | 275 | 275 | 275 | 550 | 550 | 220 |
| Electrical data (measured on | | | | | | | |
| 14 AWG copper conductor | | | | | | | |
| having 45 mil insulation | | | | | | | |
| thickness at 90° C.) | | | | | | | |
| Dielectric Constant (Initial) | — | 2.82 | 2.91 | 2.81 | 2.57 | — | — |
| Dielectric Constant (after | — | 2.82 | 2.93 | 2.80 | 2.68 | — | — |
| aging at 90° C. for 14 Days) | | | | | | | |
| Dielectric Loss Tangent (%) | — | 1.03 | 2.26 | 1.52 | 0.85 | — | — |
| (Initial) | | | | | | | |
| Dielectric Loss Tangent (%) | — | 1.03 | 2.42 | 1.53 | 1.04 | — | — |
| (after aging at 90° C. | | | | | | | |
| for 14 Days) | | | | | | | |
| Avg. Breakdown strength (V/mil) | — | 964 | 885 | 987 | 736 | — | — |
| UL Type MV105 qualification test results | — | Pass | — | — | Pass | — | — |
| Conductor Operating | — | 95.0 | — | — | 108.8 | — | — |
| Temperature at 93 amps (° C.) | | | | | | | |

Thermal conductivity was measured in accordance with ASTM E1952 (2011), mDSC method, using enthalpy values obtained from two samples, each of different thickness. Thermal conductivity values were similarly calculated from such enthalpy values. Breakdown strength was performed as prescribed by UL 2556 (2007). Regular dielectric properties were determined in accordance with ASTM D 150-9 (2004). Wet dielectric properties were tested in accordance with UL 44 LTIR procedures. Capacitance was calculated from dielectric constant and dielectric loss tangent values. Cables were also tested for UL Type MV 105 qualification. Tests conducted at room temperature were tested at about 23° C.

The conductor operating temperature of 1/0 AWG aluminum cables including an insulation layer formed of the compositions of Examples 2 and 5 are reported in Table 4. The operating temperatures were measured both with, and without, a jacket layer. The jacket layer, when included, was a high density polyethylene jacket layer having an elevated thermal conductivity of 0.4 W/mk. As can be appreciated however, cables could have also been produced using traditional jacket layers that exhibit lower thermal conductivity (e.g., 0.2 W/mk or less) using materials such as polypropylene or cross-linked polyethylene.

TABLE 4

| Conductor | | |
|---|---|---|
| Operating | Inventive | Comparative |
| Temperature | Example 2 | Example 5 |
| Insulation | 95.0 | 108.8 |
| layer only at | | |
| 93 amps (° C.) | | |
| Insulation | 91.3 | 103.7 |
| layer and | | |
| jacket layer at | | |
| 275 amps (° C.) | | |
| Insulation | 102.6 | 118.8 |
| layer and | | |
| jacket layer at | | |
| 299 amps (° C.) | | |

Additional breakdown strength testing was performed on 1/0 AWG aluminum conductor cables having an insulation formed from the composition of Inventive Example 8. The 1/0 AWG cables included a conductor shield, an insulation shield layer, and a jacket layer. The components of Inventive Example 8 and the breakdown test results of three samples are reported in Table 5.

TABLE 5

| Component | Inventive Example 8 |
|---|---|
| Ethylene-Butene Copolymer | 100 |
| Calcined clay¹ | 105 |
| Boron Nitride | 5 |
| Paraffin Wax | 5 |
| Vinyl Silane | 3 |
| Zinc Oxide | 5 |
| Antioxidant | 3 |
| UV stabilizer | 0.75 |
| Peroxide² | 2.5 |
| Total (parts) | 229.25 |
| Thermal Conductivity (W/mK) | 0.3 |
| Breakdown Strength of Un-aged | 740, 776, 669 |
| Samples (V/mil) | |
| Breakdown Strength of Samples Aged | 629, 798, 746 |
| for 120 days at 90° C. (V/mil) | |

¹Polyfil 90 by KaMin, LLC
²D-16 (Luperox) by Arkema

TABLE 6

| | Inventive Examples | | Comparative Examples | |
|---|---|---|---|---|
| | 9 | 10 | 11 | 12 |
| Component | | | | |
| Ethylene-Butene | 100 | 100 | 100 | 100 |
| Copolymer¹ | | | | |
| Calcium Carbonate | — | — | 120 | — |
| Mullite | — | — | — | 120 |
| Calcined clay² | 120 | — | — | — |
| Talc | — | 120 | — | — |
| Paraffin Wax | 5 | 5 | 5 | 5 |
| Vinyl Silane | 2 | 2 | 2 | 2 |
| Zinc Oxide | 5 | 5 | 5 | 5 |
| Antioxidant | 0.75 | 0.75 | 0.75 | 0.75 |
| UV stabilizer | 0.75 | 0.75 | 0.75 | 0.75 |
| Peroxide³ | 2.5 | 2.5 | 2.5 | 2.5 |
| Total (parts) | 236 | 236 | 236 | 236 |
| Thermal Conductivity | 0.3 | 0.32 | 0.31 | 0.29 |
| (W/mK) | | | | |
| Electricals | Dry electricals (before water aging), measured | | | |
| performance | on 45 mil plaques at room temperature | | | |
| Capacitance (pf) | 39.4 | 37.7 | 41.8 | 35.8 |
| Dielectric Loss Tangent | 0.29 | 0.37 | 0.9 | 0.4 |
| (%) | | | | |
| Dielectric constant | 2.7 | 2.5 | 3 | 2.6 |
| | After water aging at 90° C. for 56 days, | | | |
| Electricals | measured on 45 mil plaques at room | | | |
| performance | temperature | | | |
| Capacitance (pf) | 42.1 | 42.3 | 59.2 | 56.8 |
| Dielectric Loss Tangent | 0.65 | 0.68 | 1.6 | 6.6 |
| (%) | | | | |
| Dielectric Constant | 2.9 | 2.8 | 4.1 | 3.6 |

¹Engage 7447 by Dow Chemicals
²Polyfil 90 by KaMin, LLC
³D-16 (Luperox) by Arkema

Table 6 depicts additional Example compositions 9 to 12. Inventive examples 9 and 10 demonstrate the effect of different primary fillers on the physical and electrical properties of each of the thermoset compositions. Each of the compositions of inventive Examples 9 to 10 exhibit a thermal conductively of 0.29 W/mK or greater. Examples 11 and 12 are comparative because they are free of a primary filler.

TABLE 7

| | | | | Comparative | |
|---|---|---|---|---|---|
| | Inventive Examples | | | Examples | |
| Component | 13 | 14 | 15 | 16 | 17 |
| Ethylene-Butene | 100.0 | 100.0 | — | 100.0 | — |
| Copolymer¹ | | | | | |
| Polyethylene | — | — | 100.0 | — | 100.0 |
| Talc | 100.0 | 100.0 | 100.0 | 100.0 | 100.0 |
| Paraffin Wax | 5 | 5 | 5 | 5 | 5 |
| Vinyl Silane | 2 | 2 | 2 | 2 | 2 |
| Zinc Oxide | 5 | 5 | 5 | 5 | 5 |
| Antioxidant | 0.75 | 0.75 | 0.75 | 0.75 | 0.75 |
| UV stabilizer | 0.75 | 0.75 | 0.75 | 0.75 | 0.75 |
| Peroxide² | 1.0 | 2.5 | 2.5 | — | — |
| Total (parts) | 214.5 | 216.0 | 216.0 | 213.5 | 213.5 |
| Thermal Conductivity | 0.31 | 0.31 | 0.34 | 0.38 | 0.39 |
| (W/mK) | | | | | |

¹Engage 7447 by Dow Chemicals
²D-16 (Luperox) by Arkema

Table 7 depicts example compositions 13 to 17 and demonstrate the effect crosslinking has on the thermal conductivity of the composition based both on the inclusion, and variations in the quantity, of a peroxide cross-linking agent. As evidenced by inventive Examples 13 to 15, cross-linking of the polyolefin compositions decreases the thermal conductivity of each composition but each of the compositions continue to exhibit a thermal conductively of 0.31 W/mK or greater. Comparative Examples 16 and 17 exhibit high thermal conductivity but are unsuitable for use with certain power cables (e.g., medium-voltage power cables) because the polyolefin compositions are not cross-linked.

TABLE 8

| | Inventive Examples | | | | Comparative Examples | | |
|---|---|---|---|---|---|---|---|
| Component | 18 | 19 | 20 | 21 | 22 | 23 | 24 |
| Ethylene-Butene Copolymer¹ | 100 | 100 | 100 | 100 | 100.0 | 100.0 | 100.0 |
| Talc | 120 | 160 | — | — | 50.0 | — | 200.0 |
| Calcined clay² | — | — | 120 | 160 | — | 50.0 | — |
| Paraffin Wax | 5 | 5 | 5 | 5 | 5 | 5 | 5 |
| Vinyl Silane | 2 | 2 | 2 | 2 | 2 | 2 | 2 |
| Zinc Oxide | 5 | 5 | 5 | 5 | 5 | 5 | 5 |
| Antioxidant | 0.75 | 0.75 | 0.75 | 0.75 | 0.75 | 0.75 | 0.75 |
| UV stabilizer | 0.75 | 0.75 | 0.75 | 0.75 | 0.75 | 0.75 | 0.75 |
| Peroxide³ | 2.5 | 2.5 | 2.5 | 2.5 | 2.5 | 2.5 | 2.5 |
| Total (parts) | 236 | 276 | 236 | 276 | 166.0 | 166.0 | 316.0 |
| Thermal Conductivity (W/mK) | 0.31 | 0.33 | 0.28 | 0.31 | 0.24 | 0.23 | Brittle |

¹Engage 7447 by Dow Chemicals
²Polyfil 90 by KaMin, LLC
³D-16 (Luperox) by Arkema

Table 8 depicts Examples 18 to 24. Examples 18 to 24 differ in the quantity of primary filler components, talc and calcined clay, included in the composition. Inventive Examples 18 to 21 exhibit a thermal conductivity of 0.28 W/mK or greater. Insufficient quantities of the primary filler, as seen, for example, in comparative Examples 22 and 23, have low thermal conductivity. Conversely, excessive filler loading, as seen in comparative Example 24, can produce brittle thermoset compositions unsuitable for use in power cables

TABLE 9

| | | | | | Comparative |
|---|---|---|---|---|---|
| | Inventive Examples | | | | Example |
| Component | 25 | 26 | 27 | 28 | 29 |
| Ethylene- | 100 | 100 | 100 | 100 | 100 |
| Butene | | | | | |
| Copolymer¹ | | | | | |
| Talc | 80 | 90 | 100 | 120 | 60 |
| Zinc Oxide | 5 | 5 | 5 | 5 | 5 |
| Lead stabilizer | 6 | 6 | 6 | 6 | 6 |
| Vinyl Silane | 2 | 2 | 2 | 2 | 2 |
| Paraffin wax | 5 | 5 | 5 | 5 | 5 |
| Antioxidant | 3 | 3 | 3 | 3 | 3 |
| Peroxide² | 2.5 | 2.5 | 2.5 | 2.5 | 2.5 |
| Total (parts) | 203.5 | 213.5 | 223.5 | 243.5 | 183.5 |
| Elongation at | 326.5 | 283.8 | 283.4 | 210.5 | 386.2 |
| break % | | | | | |
| Thermal | 0.28 | 0.29 | 0.31 | 0.32 | 0.24 |
| conductivity | | | | | |
| (W/mK) | | | | | |

¹Engage 7447 by Dow Chemicals
²D-16 (Luperox) by Arkema

Table 9 depicts inventive Examples 25 to 28 and comparative Example 29 which illustrate the inverse relationship between thermal conductivity and elongation at break as the primary filler load is adjusted. As the primary filler loading increases, thermal conductivity rises but is offset by decreased fracture strain as measured by the elongation at break.

TABLE 10

| | Inventive | | | | |
|---|---|---|---|---|---|
| | Examples | | Comparative Examples | | |
| Component | 30 | 31 | 32 | 33 | 34 |
| EPDM¹ | 95.0 | — | 95.0 | — | — |
| Polyethylene | 5.0 | — | 5.0 | — | — |
| EPDM² | — | 100.0 | — | 100.0 | |
| EPDM³ | — | — | — | — | 100.0 |
| Calcined clay⁴ | 67.0 | — | 67.0 | — | — |
| Talc | 48.0 | — | 48.0 | — | — |
| Calcined clay⁵ | — | 120.0 | — | 120.0 | 60.0 |
| Zinc Oxide | 14.0 | 20.0 | 14.0 | 20.0 | 20.0 |
| Process oil | — | — | 9.5 | 30 | — |
| Lubricant | — | 1.0 | — | 1.0 | — |
| Vinyl Silane | 1.0 | — | 1.0 | — | 1.0 |
| Paraffin wax | 5.0 | 3.0 | 5.0 | 3.0 | 1.5 |
| Antioxidant | 1.0 | 1.0 | 1.0 | 1.0 | 1.5 |
| Peroxide⁶ | 2.5 | 2.5 | 2.5 | 2.5 | 2.5 |
| Total (parts) | 238.5 | 247.5 | 248.0 | 277.5 | 186.5 |
| Thermal | 0.27 | 0.29 | 0.24 | 0.24 | 0.22 |
| conductivity | | | | | |
| (W/mK) | | | | | |

¹Royalene 525 by Lion Polymers
²Royaledge 5041 by Lion Polymers
³Nordel 3722 P by Dow Chemicals
⁴Sanitone W(whitetex) by BASF
⁵Translink 37 by BASF
⁶D-16 (Luperox) by Arkema

Table 10 depicts additional thermoset composition Examples. EPDM and calcined clay were obtained from different commercial suppliers in Examples 30 to 34. Examples 30 and 31 are considered inventive in that thermal conductivity is at least 0.27 W/mK. Examples 32 and 33 are comparative Examples and demonstrate that high levels of process oil lower the thermal conductivity of the thermoset compositions. Example 34 is comparative in that the filler loading is insufficient and thus results in a composition having too low of a thermal conductivity.

TABLE 11

| | Inventive Examples | | | | | | |
|---|---|---|---|---|---|---|---|
| Component | 35 | 36 | 37 | 38 | 39 | 40 | 41 |
| Ethylene-Butene Copolymer¹ | 100.0 | 70.0 | — | — | — | — | — |
| Ethylene-Propylene Rubber | — | — | 100.0 | 70.0 | — | — | — |
| Ethylene-Butene Copolymer² | — | — | — | — | 100.0 | 70.0 | — |
| EPDM³ | — | — | — | — | — | — | 100.0 |
| Ethylene-Octene Copolymer | — | 30.0 | — | 30.0 | — | 30.0 | — |
| Talc | 100.0 | 100.0 | 100.0 | 100.0 | 100.0 | 100.0 | 100.0 |
| Boron Nitride | 5.0 | 5.0 | 5.0 | 5.0 | 5.0 | 5.0 | 5.0 |
| Paraffin wax | 5.0 | 5.0 | 5.0 | 5.0 | 5.0 | 5.0 | 5.0 |
| Zinc Oxide | 5.0 | 5.0 | 5.0 | 5.0 | 5.0 | 5.0 | 5.0 |
| Vinyl Silane | 2.0 | 2.0 | 2.0 | 2.0 | 2.0 | 2.0 | 2.0 |
| Antioxidant | 3.0 | 3.0 | 3.0 | 3.0 | 3.0 | 3.0 | 3.0 |
| Lead stabilizer | 6.0 | 6.0 | 6.0 | 6.0 | 6.0 | 6.0 | 6.0 |
| Peroxide⁴ | 2.5 | 2.5 | 2.5 | 2.5 | 2.5 | 2.5 | 2.5 |
| Total (parts) | 228.5 | 228.5 | 228.5 | 228.5 | 228.5 | 228.5 | 228.5 |
| Mooney viscosity at | 10.35 | 9.82 | 25.48 | 17.90 | 7.34 | 6.32 | 44.59 |
| 150° C. (ML) | | | | | | | |

¹Engage 7447 by Dow Chemicals
²Exact 4006 by ExxonMobil
³Royaledge 5041 by Lion Polymers
⁴Perkadox BC-FF by Akzonobel

Table 11 depicts the effect selection of the base polymer can have on the viscosity of each example thermoset composition. The Mooney viscosity for each example was obtained use of a Mooney viscometer and measured at about 150° C.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

What is claimed is:

1. A thermoset composition comprising:
about 100 parts, by weight of the thermoset composition, of a cross-linked polyolefin;
from about 80 parts to about 160 parts, by weight of the thermoset composition, of a primary filler, the primary filler selected from the group consisting of talc, calcined clay, and combinations thereof;
a secondary filler comprising one or more of a metal oxide and a metal nitride; and
from about 0.5 part to about 10 parts, by weight of the thermoset composition, of at least one of a composition stabilizer and an antioxidant; and
wherein the thermoset composition exhibits a thermal conductivity of about 0.27 W/mK or greater, a dielectric loss tangent of about 3% or less when measured at about 90° C. after water aging at about 90° C. for about eight weeks, or both.

2. The thermoset composition of claim 1 exhibits a thermal conductivity of about 0.30 W/mK or greater.

3. The thermoset composition of claim 1 wherein the weight of the secondary filler is about 50% or less of the total weight of the primary filler and the secondary filler.

4. The thermoset composition of claim 1, wherein the secondary filler is selected from the group consisting of zinc oxide, magnesium oxide, aluminum oxide, silicon dioxide, boron nitride, aluminum nitride, and combinations thereof.

5. The thermoset composition of claim 1 further comprising from about 0.5 parts to about 5 parts, by weight of the thermoset composition, of a surface treatment agent.

6. The thermoset composition of claim 1 further comprising about 5 parts or less, by weight of the thermoset composition, of a processing oil.

7. The thermoset composition of claim 1, wherein the composition stabilizer comprises at least one of a UV stabilizer, a heat stabilizer, a lead stabilizer and a metal deactivator.

8. The thermoset composition of claim 1 is substantially lead-free.

9. The thermoset composition of claim 1, wherein the cross-linked polyolefin comprises one or more of an ethylene-butene copolymer, ethylene-propylene-diene terpolymer, ethylene-octene copolymer, ethylene-propylene rubber, and a polyethylene.

10. The thermoset composition of claim 1, wherein about 80% or more of the said fillers have an average particle size about 20 microns or less.

11. The thermoset composition of claim 1 has an elongation at break of about 200% or more.

12. The thermoset composition of claim 1 has a break down strength of about 500 V/mil or more.

13. The thermoset composition of claim 1 has a Mooney viscosity of about 30 ML or less at about 150° C.

14. The thermoset composition of claim 1 has a dielectric constant of about 3.5 or less when measured at about 90° C.

15. The thermoset composition of claim 1 has a dielectric loss tangent of about 2.5% or less when measured at about 90° C.

16. A cable comprising an insulation layer and optionally a jacket layer, wherein one or more of the insulation layer and the jacket layer is formed from the thermoset composition of claim 1.

17. A cable comprising:
a conductor;
an insulation layer surrounding the conductor, the insulation layer formed from a thermoset composition, the thermoset composition comprising:
about 100 parts, by weight of the thermoset composition, of a cross-linked polyolefin;
from about 80 parts to about 160 parts, by weight of the thermoset composition, of a primary filler, the primary filler selected from the group consisting of talc, calcined clay, and combinations thereof;
a secondary filler comprising one or more of a metal oxide and a metal nitride; and
from about 0.5 part to about 10 parts, by weight of the thermoset composition, of at least one of a composition stabilizer and an antioxidant; and
wherein the thermoset composition exhibits a thermal conductivity of about 0.27 W/mK or greater, a dielectric loss tangent of about 3% or less when measured at about 90° C. after water aging at about 90° C. for about eight weeks, or both.

18. The cable of claim 17, further comprising a jacket layer surrounding the insulation layer.

19. The cable of claim 17, wherein the conductor has an operating temperature of about 5° C. or less relative to a comparative cable having a similar conductor but a different insulation layer.

20. The cable of claim 17, wherein the conductor has an operating temperature of about 5° C. or less relative to a similar conductor in a different cable having a different insulation layer, wherein the different insulation exhibits a thermal conductivity of about 0.27 W/mK or greater, a dielectric loss tangent of about 3% or less when measured at about 90° C. after water aging at about 90° C. for about eight weeks, or both.
